(19) United States
(12) Patent Application Publication
(10) Pub. No.: US 2005/0059158 A1
(43) Pub. Date: Mar. 17, 2005

(54) Method of performing an assay, apparatus therefor, and a method of manufacturing and apparatus

(75) Inventors: Ventzeslav Petrov Iordanov, Delft (NL); Pasqualina Maria Sarro, Delft (NL); Reinoud Felix Wolffenbuttel, Delft (NL); Michael Johannes Vellekoop, Vienna (AT)

Correspondence Address: PEACOCK MYERS AND ADAMS P C, P O BOX 26927, ALBUQUERQUE, NM, 871256927, US

(73) Assignee: Technische Universiteit Delft, Delft (NL)

(21) Appl. No.: 10/700,864

(22) Filed: Nov. 3, 2003

Related U.S. Application Data
(63) Continuation of application No. PCT/NL02/00287, filed on May 2, 2002.

(30) Foreign Application Priority Data
May 3, 2001 (NL) 1017989

(51) Int. Cl. G01N 21/00

(52) U.S. Cl. 436/172; 422/82.05

(57) ABSTRACT

The invention relates to a method of performing a fluorescence assay. According to the invention a filter is integrated with at least one component chosen from i) a body comprising a well, wherein the well in which the assay is being performed is exposed to excitation light in such a manner that the filter is positioned between the light-sensitive element and the excitation light source, and ii) a light-sensitive element, wherein the filter is applied at least at the light-sensitive side of the surface of the light-sensitive element, and any light that may be emitted is detected by means of the light-sensitive element. The invention also relates to an apparatus suitable for carrying out the method, as well as a method for its manufacture.

The present invention relates to a method of performing an assay comprising detection by measuring any light that may be emitted after excitation by an excitation light source, wherein at least one agent is contacted with a sample in a well of a body, and after the agent has been contacted with the sample, the well is exposed to the excitation light, and any light that may be emitted is detected.

Such a method is generally known, in particular for performing fluorescence-based assays. These assays include, among others, immunoassays or enzyme assays. In the case of the first, antibodies or antigens are often used that are labelled with a fluorescent group, or provided with a chelated label e.g. one of a rare earth metal ion (such as Europium) which, after the addition of a suitable adjuvant or mixture of adjuvants, may fluoresce. In the case of an enzyme assay, the substrate or its conversion product may be fluorescent. It is also possible to measure a cofactor, in particular a coenzyme such as NAD(H), NADP(H) or ATP. Depending on the reaction performed, these are consumed or formed. The methods may be performed in an array of wells for taking parallel measurements on one or several samples at one or several concentrations. To carry out the measurement, the well is illuminated with excitation light, and emission light is detected with the aid of a light-sensitive element such as a photomultiplier. In order to adequately prevent excitation light from reaching the light-sensitive element, suitable measures are taken, such as measuring the emission light under an angle with an excitation beam, and using a filter that blocks excitation light, such as an interference filter.

Such a method for performing an assay is relatively expensive and requires a sizeable apparatus with the light-sensitive element being located at an ineffectual distance from the well.

It is the object of the present invention to provide a method of the above-mentioned kind, resolving these disadvantages at least to some degree.

To this end the method according to the invention is characterized in that the filter is integrated with at least one component chosen from i) the body comprising a filter for blocking excitation light and transmitting emission light, wherein the well in which the assay is being performed is exposed to excitation light in such a manner that the filter is positioned between the light-sensitive element and the excitation light source, and ii) the light-sensitive element, wherein the filter is applied at least at the light-sensitive side of the surface of the light-sensitive element, and any light that may be emitted is detected by means of the light-sensitive element.

In this way it is possible to limit the size of a measuring apparatus and to place the light-sensitive element closer to the well.

To further limit the size of the apparatus and in order to provide a method for which still less space is required, and by which optionally a very large number of assays can be performed, in accordance with a very favourable embodiment of the method according to the invention the assay is performed in a well comprising a wall defining the well, which at least over a part of its surface is provided with a light-sensitive element incorporated in the body, and in which the filter is provided between the light-sensitive element and the surface of the inner wall, and the light-sensitive element integrated in the body is read out.

By integrating the light-sensitive element and the filter in the body comprising the well, the above mentioned objectives are achieved, while in addition considerably simplifying further problems such as aligning the necessary components required for taking a measurement. Such a method further allows extensive miniaturisation, in particular also without thereby increasing optical alignment problems, while increasing the number of assays that can be performed. The assays can be performed economically. One assay according to the invention is particularly an assay based on fluorescence, phosphorescence of an energy transmission. In the present application the term “wall” also encompasses the bottom of the well.

The filter used may be an interference filter, but it is preferred to use an absorbing filter.

Such a filter may be applied more easily and at lower cost.

As absorbing material for the absorbing filter it is preferred to use a semiconductor material or a metal.

In addition to (possible) reflecting properties such materials may have, a semiconductor material and metal also possess absorbing properties. In combination, a very good exclusion of excitation light may be obtained.

According to an important preferred embodiment, the semiconductor material is chosen from germanium, gallium phosphide and (poly)crystalline silicon.

In essence, such materials themselves have no fluorescence that could upset a measurement.

These materials possess excellent optical properties for many much-used emission wavelengths. In this respect it is in particular (poly)crystalline silicon that is suitable for the detection of NAD(P)H and ATP. This adequately blocks excitation light of relatively short wavelengths and sufficiently transmits emission light.

The absorbing filter preferably comprises one absorbing layer.

This constitutes a considerable saving in costs, especially compared with interference filters, which require many layers of a predetermined refractive index and thickness to be applied under well-defined conditions.

Advantageously an array of wells is used, all of which are illuminated simultaneously with excitation light, and all the light-sensitive elements are read out.

In this way it is possible to perform and process, for example, 10,000 assays simultaneously.

According to a first preferred embodiment a photodiode is used as the light-sensitive element that covers at least 50% of the surface of the bottom of the well.

Although photodiodes are not very sensitive, their proximity to the well still allows a proper measurement, as can be seen from the example.

According to an alternative embodiment a CCD is used as the light-sensitive element.

This allows measurements of lower emission levels to be taken.

According to an important application the assay comprises a reaction involving NADH, NADPH or ATP as substrate or reaction product.

The invention also relates to an apparatus for performing the above mentioned assay, which apparatus comprises a body provided with a well having an inner wall, which at least over part of its surface is provided with a light-sensitive element incorporated in the body, the body between the light-sensitive element and the surface of the inner wall being provided with a filter for blocking excitation light and allowing emission light to pass through, the well is exposed to excitation light with the filter being positioned between the light-sensitive element and the excitation light source, and any light that may be emitted is detected by the light-sensitive element.

The subclaims 12 to 18 describe preferred embodiments, whose advantages are essentially those described above for performing the method according to the invention.

Finally, the invention relates to a method for manufacturing such an apparatus, which is characterized in that a light-sensitive element produced with the aid of IC techniques is provided with a layer of amorphous silicon, which layer of amorphous silicon is treated to form poly)crystalline silicon.

The use of techniques from the chip technology makes it possible to economically produce a very high density of wells on or in a body.

To reach the temperature of 1000° C., treatment is preferably performed with the aid of a laser at a wavelength that is absorbed by the amorphous silicon, and more particularly, the amorphous silicon is preferably treated at a wavelength of less than 400 nm, and at between 50 and 500 mJ/cm².

This is a very simple manner of producing an absorbing filter with properties that make it especially suitable for taking measurements on the above mentioned coenzyme/cofactors.

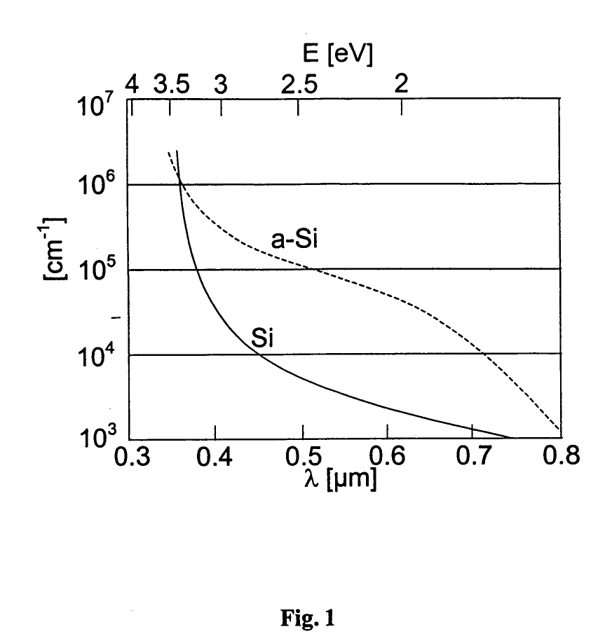

The invention will now be explained with reference to the drawings and the example in which FIG. 1 shows the absorption coefficient plotted against the wavelength for amorphous Si and crystalline Si; and

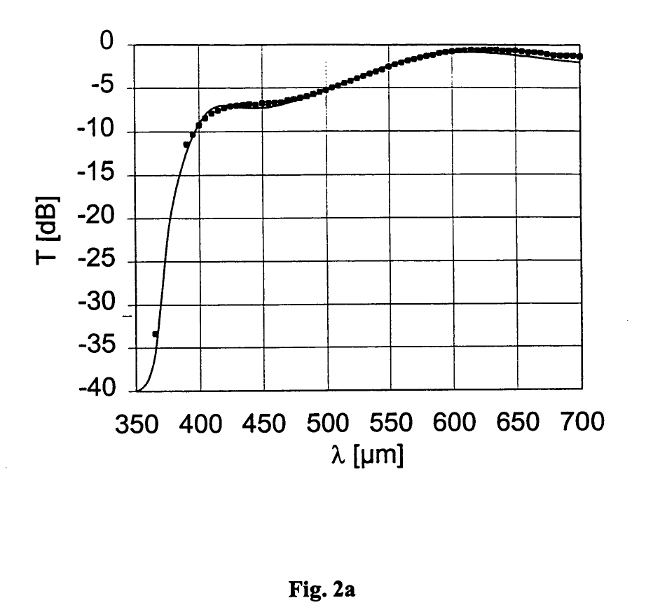

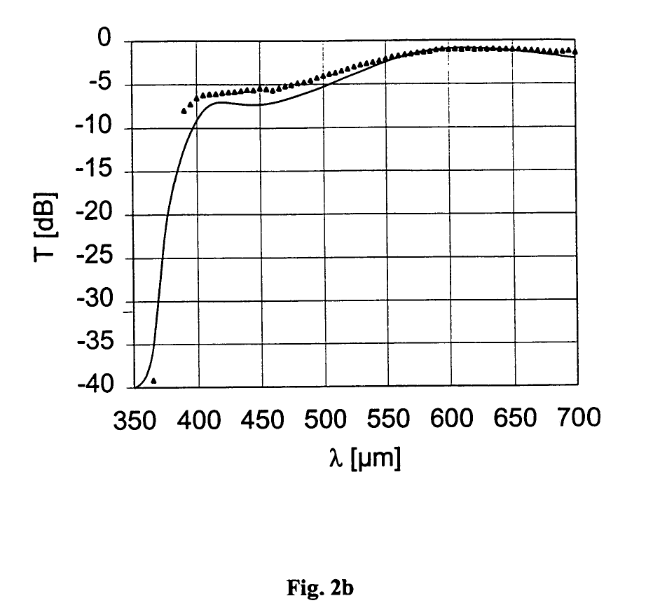

FIG. 2a and 2b, respectively, show the calculated and the measured transmission of a poly crystalline silicon layer having small and large granules, respectively.

There are enzyme reactions that can be monitored by measuring the conversion of NAD (Nicotinamide Adenine Dinucleotide) to the fluorescent product NADH. NADH absorbs light at a wavelength of 340 nm (peak), exhibiting maximum emission at 450 nm. To optimally block out ultraviolet excitation light and adequately transmit the fluorescence light of NADH, a propitious choice in accordance with the present invention is crystalline silicon. As shown in FIG. 1, the absorption coefficient (A) of crystalline silicon drops very sharply to lower wavelengths (λ). In order to guarantee that sufficient photons are able to pass through for a detectable signal, it is necessary to ensure that the layer of crystalline silicon is not too thick. Using techniques that are generally known in the art, semiconductor circuits can be produced by applying silicon to a substrate. However, such a layer of silicon is amorphous, whereas the intended application requires crystalline silicon. Amorphous silicon may be made crystalline by treating it with an excimeric laser as described by Ishihara R. et al. (Jpn. J. Appl. Phys. 34, Vol. 1, No. 4A, pp. 1759-1764 (1995)). The fact that amorphous silicon strongly absorbs much light ensures not only that the temperature necessary for crystallisation can be reached easily, but also that a light-sensitive element underneath it will not be damaged during treatment with UV light.

To determine a suitable thickness for the crystalline silicon layer and testing whether the optical characteristics are adequate for the intended purpose, a layer of amorphous silicon having a thickness of 75 nm was applied to a glass substrate using LPCVD (Low Pressure Chemical Vapour Deposition). The layer thus produced was subjected to 100 pulses of excimeric light (XMR 5121 Laser Planarisation System, wavelength=308 nm; energy per pulse=100-600 mJ; duration of pulse=66 ns (FWHM); max. mean power=150 W; peak capacity=10 MW (XMR, Santa Clara, United States of America) at an energy of 290 mJ/cm² or 540 mJ/cm². Scanning electron microscopy showed that crystalline silicon formed at the lowest energy had a granule size of approximately 1 micron, while at the higher energy the granule size was approximately 5 microns.

The optical properties (transmission and absorption) of the film layers were simulated with the aid of the programme TFCalc (Thin Film Design Software, version 2.9, Software Spectra Inc., W. Harvest Lane, Portland, Oreg., United States of America) and measurements were taken with the aid of a calibrated Hamamatsu S1226 diode (Hamamatsu Photonics K.K., Hamamatsu City, Japan). For measuring in the UV, an argon laser was used adjusted at 365 nm, (model 2020-05, Spectra Physics, Mountain View, United States of America) at a power of 240 mWm⁻². The results for the silicon layers with the small and large granules sizes, respectively, are shown in the FIGS. 2a and 2b. It can be seen that there is an excellent correlation between the calculated results and the measured results. The substrate thus produced possesses the optical properties necessary for the intended purpose. To produce an array of wells, walls may be formed with the aid of, for example, photo resist techniques. The dimension of the wells are, for example, 200 μm*200 μm*4 μm. Of course it is also possible to first produce a substrate with wells and subsequently provide this with a filter. If no light-sensitive elements are incorporated in this substrate, the filter may also be located at the opposite side where no wells are provided.

1. A method of performing an assay comprising detection by measuring any light that may be emitted after excitation by an excitation light source, wherein at least one agent is contacted with a sample in a well of a body, and after the agent has been contacted with the sample, the well is exposed to the excitation light, detecting any light that my be emitted, wherein a filter is integrated with at least one component chosen from i) the body, which comprises a filter for blocking excitation light and transmitting emission light, wherein the well in which the assay is being performed is exposed to excitation light in such a manner that the filter is positioned between the light-sensitive element and the excitation light source, and ii) the light-sensitive element, wherein the filter is applied at least at the light-sensitive side of the surface of the light-sensitive element, and any light that may be emitted is detected by means of the light-sensitive element.

2. A method according to claim 1, wherein the assay is performed in a well comprising a wall defining the well, which at least over a part of its surface is provided with a light-sensitive element incorporated in the body, and in which the filter is provided between the light-sensitive element and the surface of the inner wall, and the light-sensitive element integrated in the body is read out.

3. A method according to claim 1, wherein the filter is an absorbing filter.

4. A method according to claim 3, wherein the absorbing material for the absorbing filter is a layer of a semiconductor material or metal.

5. A method according to claim 4, wherein the semiconductor material is a material chosen from germanium, gallium phosphide and polycrystalline silicon.

6. A method according to claim 3, wherein the absorbing filter comprises one absorbing layer.

7. A method according to claim 1, wherein an array of wells is used, all of which are illuminated simultaneously with excitation light, and all the light-sensitive elements are read out.

8. A method according to claim 1, wherein a photodiode is used as the light-sensitive element that covers at least 50% of the surface of the bottom of the well.

9. A method according to claim 1, wherein a CCD is used as the light-sensitive element.

10. A method according to claim 1, wherein the assay comprises a reaction involving NADPH or ATP as substrate or reaction product.

11. An apparatus for performing an assay, which apparatus comprises a body provided with a well, wherein the body is provided with a filter for blocking excitation light and allowing emission light to pass through.

12. An apparatus according to claim 11, wherein the well comprises a wall defining the well, which at least over a part of its surface is provided with a light-sensitive element incorporated in the body, and in which the filter is provided between the light-sensitive element and the surface of the inner wall.

13. An apparatus according to claim 11, wherein the filter is an absorbing filter.

14. An apparatus according to claim 13, wherein the absorbing filter for excitation light is a layer of semiconductor material or a metal.

15. An apparatus according to claim 14, wherein the semiconductor material is a material chosen from germanium, gallium phosphide and polycrystalline silicon.

16. An apparatus according to claim 13 wherein the absorbing filter comprises one layer of absorbing material.

17. An apparatus according to claim 12, wherein the light-sensitive element is a photodiode that covers at least 50% of the surface of the bottom of the well.

18. An apparatus according to claim 17, wherein the light-sensitive element is a CCD.

19. A method of manufacturing an apparatus according to claim 12, wherein a light-sensitive element produced with the aid of IC techniques is provided with a layer of amorphous silicon, which layer of amorphous silicon is treated to form polycrystalline silicon.

20. A method according to claim 19, wherein to reach a temperature of 1000° C., the method is performed with the aid of a laser at a wavelength that is absorbed by the amorphous silicon.

21. A method according to claim 20, wherein the amorphous silicon is treated at a wavelength of less than 400 nm and at between 50 and 500 mJ/cm².
